(19) United States
(12) Patent Application Publication
(10) Pub. No.: US 2025/0376891 A1
(43) Pub. Date: Dec. 11, 2025

(54) STACKING SCREEN DOOR

(71) Applicants: Wei-Chao WANG, New Taipei City (TW); Luxtech Design LLC., New York, NY (US)

(72) Inventor: Wei-Chao WANG, New Taipei City (TW)

(21) Appl. No.: 18/735,476

(22) Filed: Jun. 6, 2024

(51) Int. Cl. E05F 15/681; E05D 15/22; H05K 5/00

(52) U.S. Cl. CPC E05D 15/22; E05D 2015/225; E05Y 2900/106; E06B 2009/247; E06B 3/927

(57) ABSTRACT

A stacking screen door has two rails and multiple door panels. Each one of the rails has a groove, a conductive bar, and an elastic assembly. The conductive bar is movably located in the groove. The elastic assembly is connected to the conductive bar and the groove, and is configured to push the conductive bar out of the groove. The door panels selectively move along the two rails and are sequentially connected vertically to each other in the rail. Each one of the door panels has two electric assemblies and multiple display screens. Each one of the display screens is electrically connected to the two electric assemblies. When each one of the door panels moves along the two rails, each one of electric assemblies is respectively connected to the conductive bar. Therefore, power can be supplied to the display screens.

### BACKGROUND OF THE INVENTION

### FIELD OF THE INVENTION

The present invention relates to a stacking door, especially to a stacking electric door comprising display screens.

### Description of the Prior Arts

Stacking doors can be mounted in various places, such as schools, stores, or even garages, and are configured to divide areas into sub-areas. In general, the stacking door comprises multiple door panels, two rails, and a storage area. When the stacking door is open, the door panels are separated from each other and arranged in the storage area; when the stacking door is closed, the door panels move along the rails, and connect vertically to form a wall.

Nowadays, a stacking screen door is provided, which is equipped with display screens on each one of the door panels, and each one of the door panels respectively comprises electric assemblies. The electric assemblies are connected to each one of the door panels, and carry out signal transmission. Therefore, the door panels form a large screen, which can be used for multimedia purposes such as showing videos or advertisements.

However, during the descent of the stacking screen door or when the stacking screen door is only partially descending, the electric assemblies are not fully connected, and the signals cannot be transmitted at that time, so the display screen cannot be used. In addition, if the electric assembly at the top of the stacking screen door or in the middle of the stacking screen door is broken, the other door panels below the faulty electric assembly will not be able to receive signals. If there are multiple door panels with faulty electric assemblies at the same time, it will take more time and effort to find the faulty door panels for repair.

To overcome the shortcomings, the present invention provides a stacking screen door to mitigate or obviate the aforementioned problems.

### SUMMARY OF THE INVENTION

The main objective of the present invention is to provide a stacking screen door that is capable of energizing the display screen on the door even when only part of the door panels of the door is descended.

The stacking screen door comprises a storage area, a driving assembly, two rails, and multiple door panels. The driving assembly is located in the storage area.

The two rails are respectively mounted on the two sides underneath the storage area and extend from the storage area to the ground level. Each one of the rails respectively comprises a groove, a conductive bar, and an elastic assembly. The groove extends from the storage area to the ground level and is parallel to the rail. The conductive bar is movably located in the groove and extends from the storage area to the ground level. The elastic assembly is connected to the conductive bar and the groove, and the elastic assembly is configured to push the conductive bar out of the groove.

The door panels are connected to the driving assembly. The door panels are selectively mounted in the storage area. The door panels selectively move along the two rails and are connected vertically to each other in the two rails. Each one of the door panels comprises two electric assemblies and multiple display screens. The two electric assemblies are respectively located on the two sides of the door panel. The multiple display screens are respectively mounted on the door panels, and each one of the display screens is electrically connected to the two electric assemblies. When each one of the door panels moves along the two rails, each one of the electric assemblies is respectively connected to the conductive bar.

The advantage of the present invention is that as soon as one single door panel enters the rail, the display screens on the door panel can receive electrical energy, no need to wait for the stacking screen door to close completely. In addition, since each one of door panels is an independent circuit, when the electric assembly of one of the door panels is broken, the operation of the display screens of the other door panels remains unaffected.

Other objectives, advantages and novel features of the invention will become more apparent from the following detailed description when taken in conjunction with the accompanying drawings.

### BRIEF DESCRIPTION OF THE DRAWINGS

FIG. 1 is a front view of a stacking screen door in accordance with the present invention;

FIG. 2 is a side view of the stacking screen door in FIG. 1 when the stacking screen door is open;

FIG. 3 is a side view of the stacking screen door in FIG. 1 when the stacking screen door is closed;

FIG. 4 is a top view of two rails and a door panel in FIG. 1;

FIG. 5 is a partial enlargement view of the rail and the door panel in FIG. 1;

FIG. 6 is a cross-sectional view of the rail and the door panel in FIG. 1;

FIG. 7 is a cross-sectional view of the rail and the door panel in another embodiment in FIG. 1;

FIG. 8 is a perspective view of the rails and the door panels in FIG. 1; and

FIG. 9 is a front view of the door panel in FIG. 1.

### DETAILED DESCRIPTION OF THE PREFERRED EMBODIMENTS

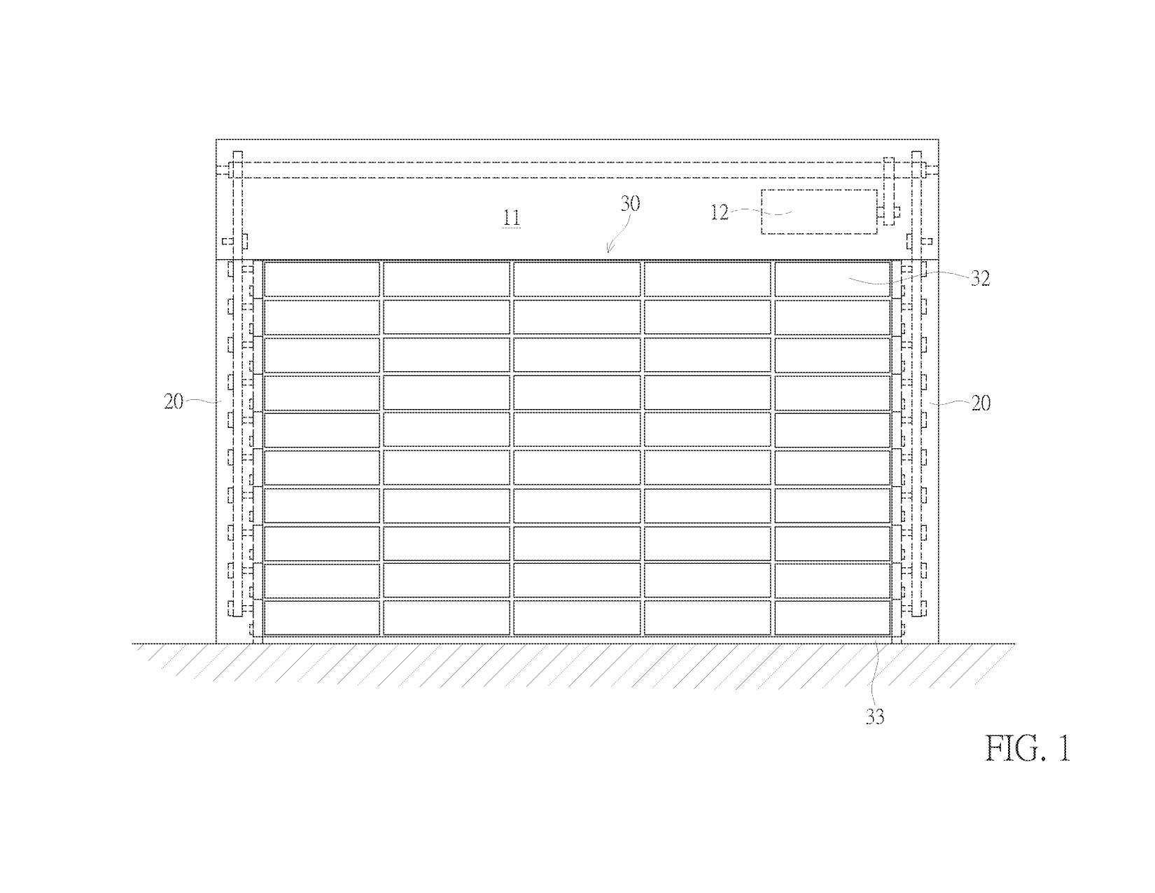

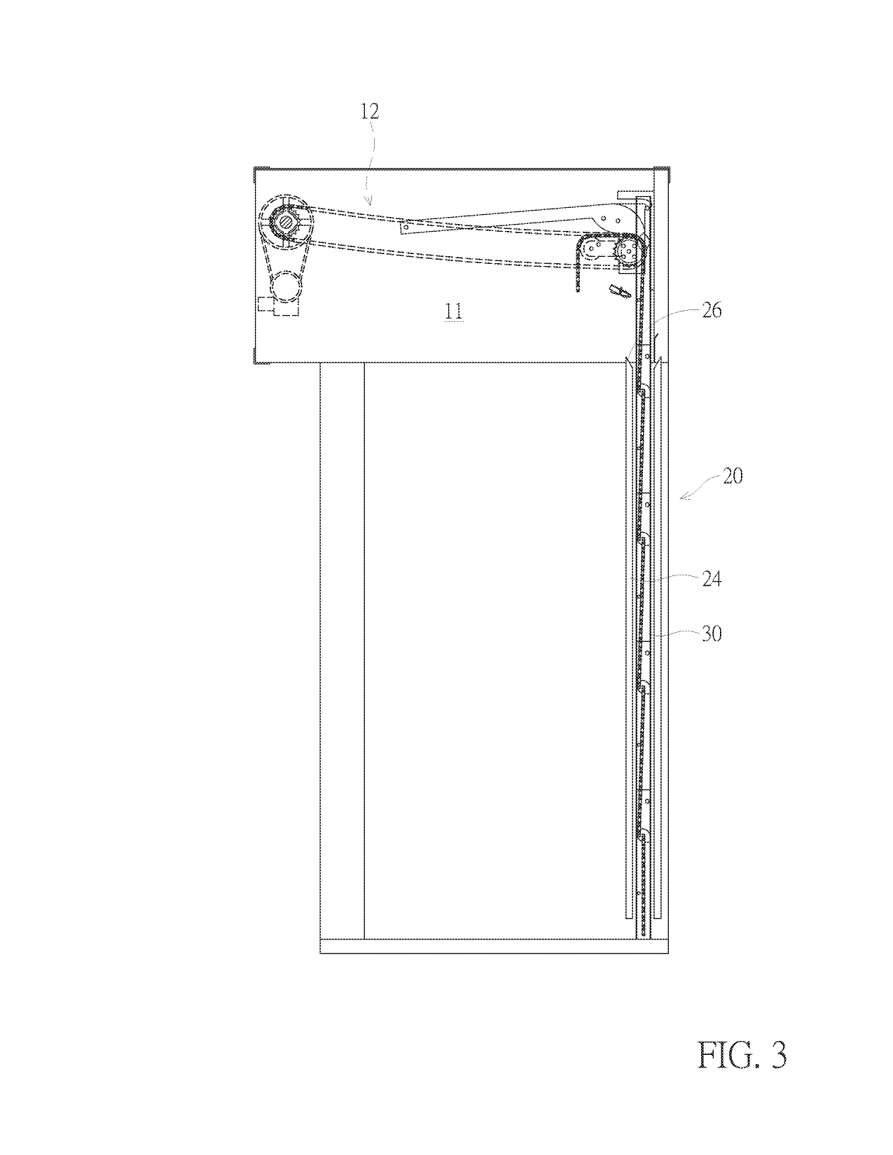

With reference to FIG. 1 to FIG. 3, the present invention provides a stacking screen door. The stacking screen door comprises a storage area 11, a driving assembly 12, two rails 20 and multiple door panels 30. The storage area 11 is located on the top of the stacking screen door. The driving assembly 12 is mounted in the storage area 11 and configured to control the opening and closing of the stacking screen door.

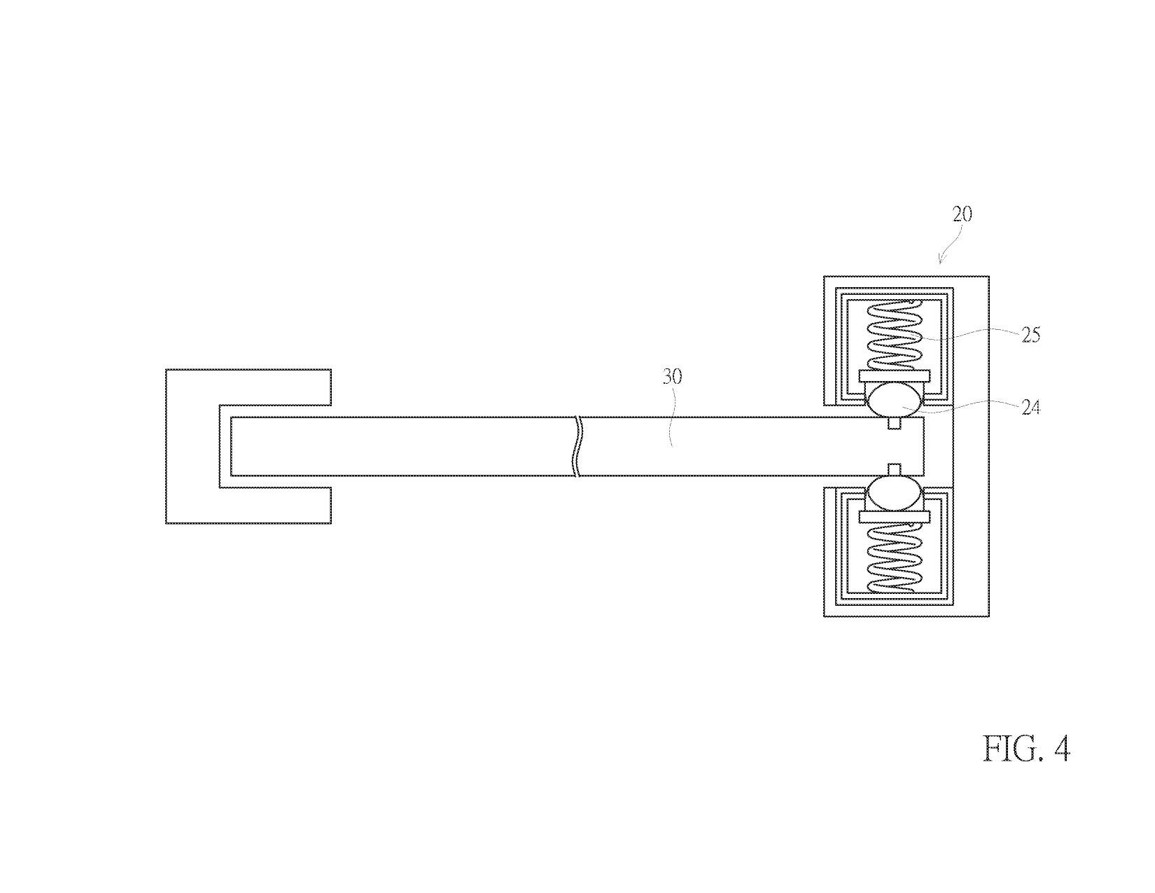

Then please refer to FIG. 4 to FIG. 6. The two rails 20 are respectively mounted on two sides underneath the storage area 11 and extend from the storage area 11 to the ground level. Each one of the rails 20 comprises a groove 21, an insulation layer 22, a metal layer 23, a conductive bar 24, an elastic assembly 25, and an incline 26. The two rails 20 are respectively connected to a positive electrode and a negative electrode of a power supply. In this embodiment, one of the rails 20 comprises two grooves 21, two conductive bars 24, two insulation layers 22, two metal layers 23, and two elastic assemblies 25. The openings of the two grooves 21 are opposite to each other so that the conductive bars 24 protrude towards each other. The two conductive bars 24 of the same rail 20 are connected to the same electrode of the power supply. In another embodiment, the two rails 20 both comprise two conductive bars 24. The two conductive bars 24 of one of the rails 20 are both connected to the positive electrode of the power supply, and the two conductive bars 24 of the other rail 20 are both connected to the negative electrode of the power supply. Each one of the two rails 20 comprises a conductive bar 24, and the two rails 20 are respectively connected to the positive electrode and the negative electrode of the power supply.

The groove 21, the insulation layer 22, the metal layer 23, and the conductive bar 24 all extend from the storage area 11 to the ground level and are parallel to the rail 20. The insulation layer 22 and the metal layer 23 are both mounted in the groove 21, precisely the insulation layer 22 covers the inner surface of the groove 21, and the metal layer 23 covers the insulation layer 22.

The conductive bar 24 and the elastic assembly 25 are mounted in the groove 21. In other words, the groove 21 surrounds the conductive bar 24 and the elastic assembly 25. In this embodiment, the insulation layer 22 and the metal layer 23 also surround the conductive bar 24 and the elastic assembly 25. The rail 20 consists of the groove 21, the insulation layer 22, the metal layer 23, the conductive bar 24 and the elastic assembly 25 in order from outside to inside. The groove 21 comprises an opening, and the elastic assembly 25 is configured to push the conductive bar 24 out from the opening of the groove 21.

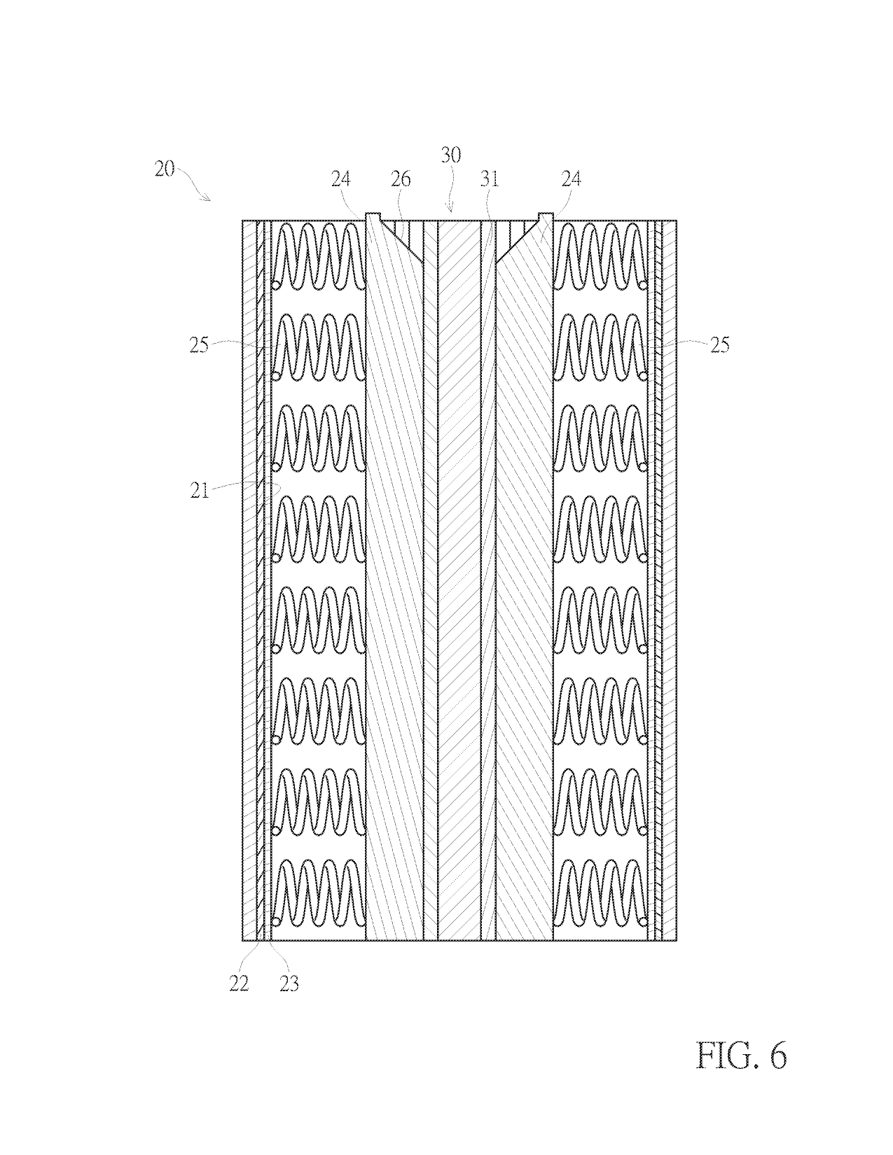

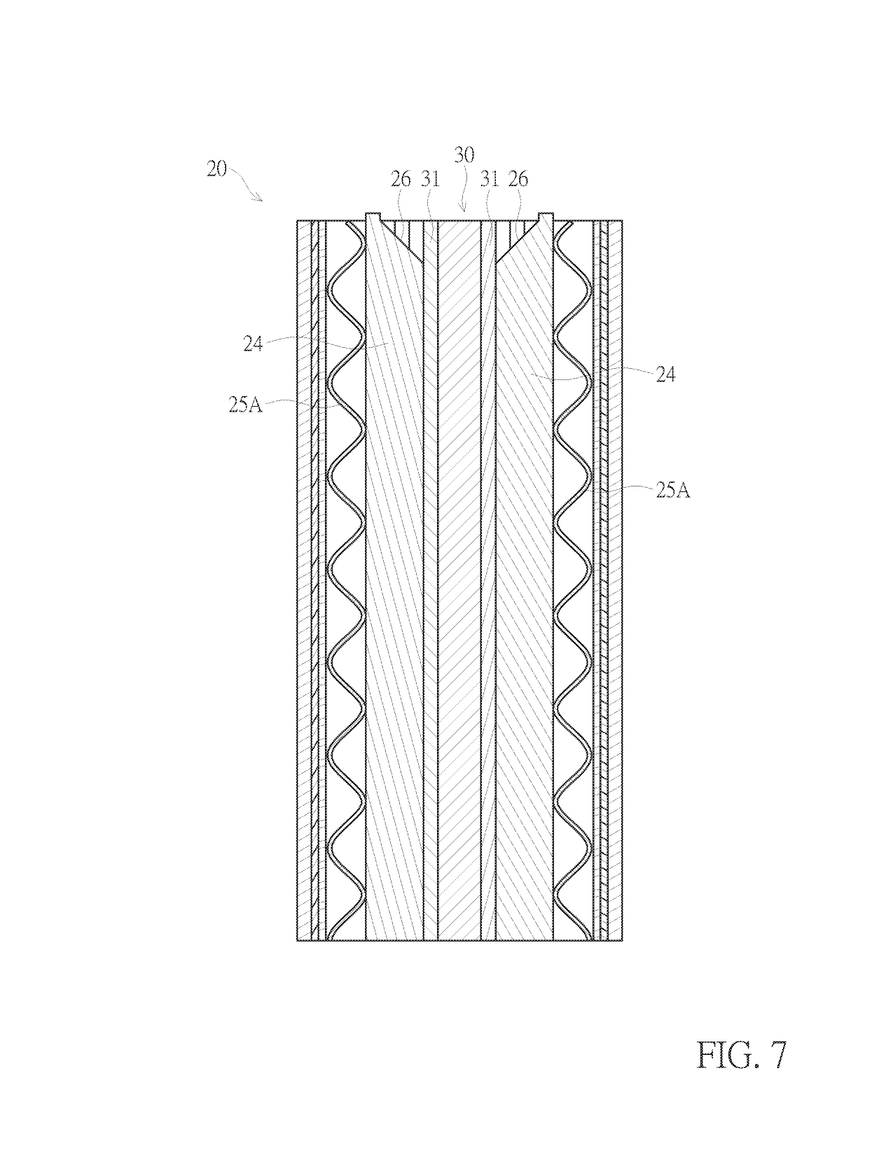

With reference to FIG. 6, in this embodiment, the elastic assembly 25 can be multiple springs. The springs are arranged in parallel from top to bottom along the conductive bar 24, and the two ends of the spring are connected to the conductive bar 24 and the metal layer 23 respectively. In another embodiment, with reference to FIG. 7, the elastic assembly 25A comprises a wave structure comprising multiple peaks and multiple troughs. The peaks and the troughs are arranged staggered, the peaks are connected to the conductive bar 24, and the troughs are connected to the metal layer 23. The structure of the elastic assembly 25 is not limited to the above description, as long as the elastic assembly 25 is configured to push the conductor bar 24 out of the groove 21.

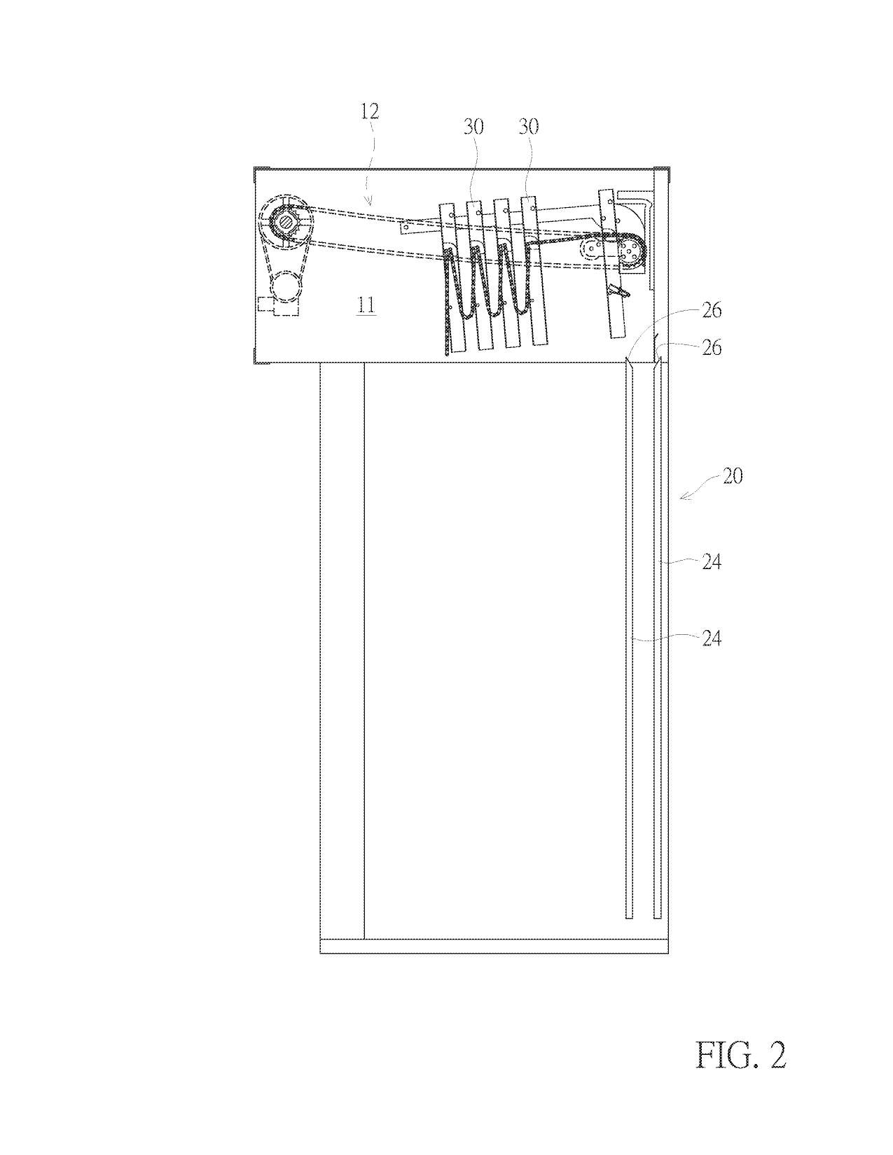

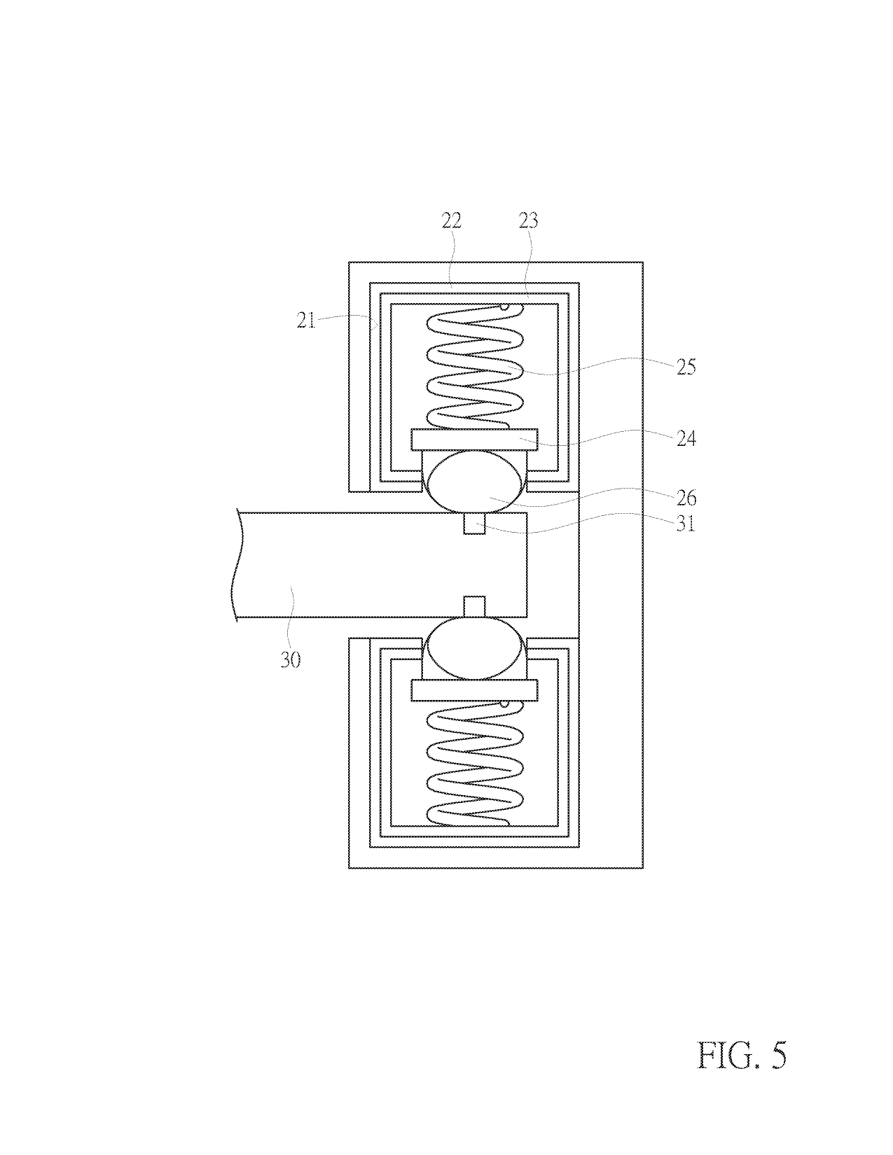

Then please refer to FIG. 2, FIG. 5, and FIG. 6. The incline 26 is located at one end of the rail 20 near the storage area 11. In other words, the groove 21, the conductive bar 24, the insulation layer 22 and the metal layer 23 can also comprise the incline 26. In this embodiment, the incline 26 is formed on the top of the conductive bar 24, and precisely the inclines 26 on the two conductive bars 24 in the same rail 20 are inclined downward toward each other.

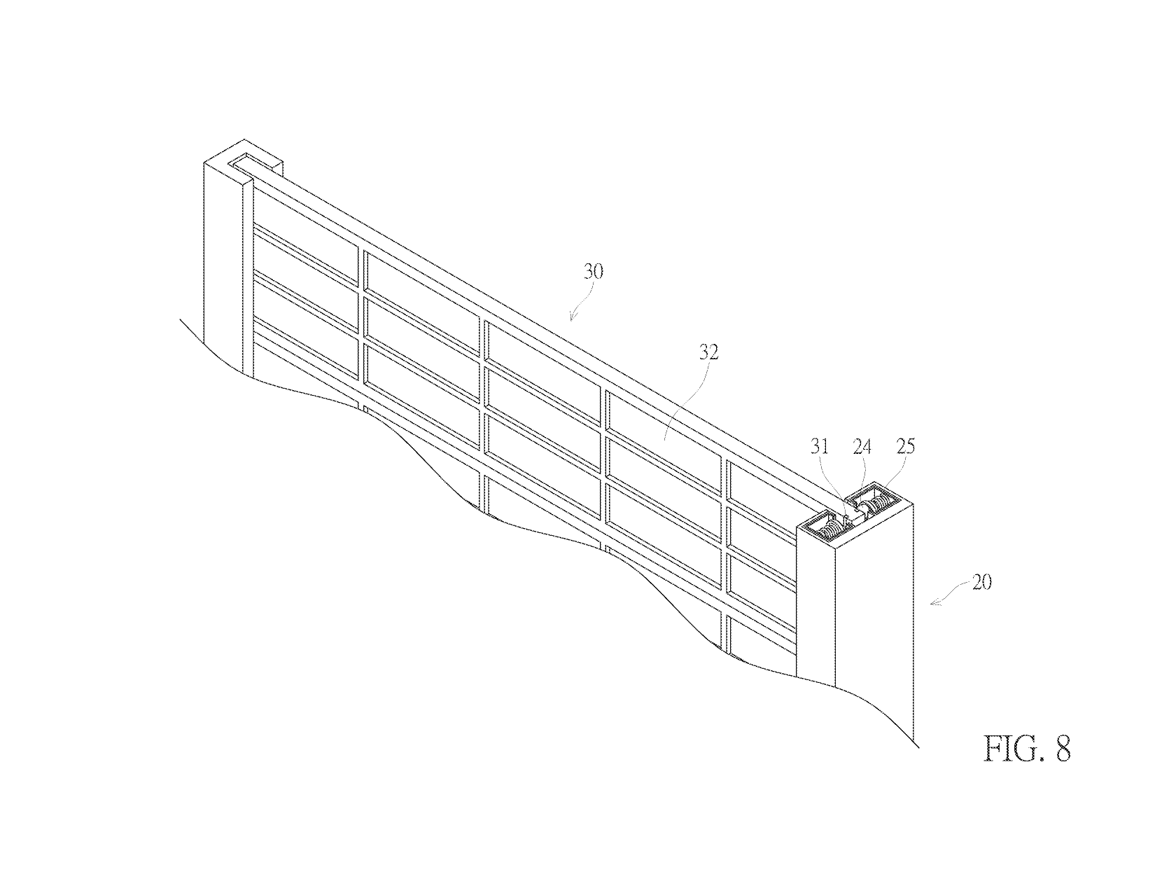

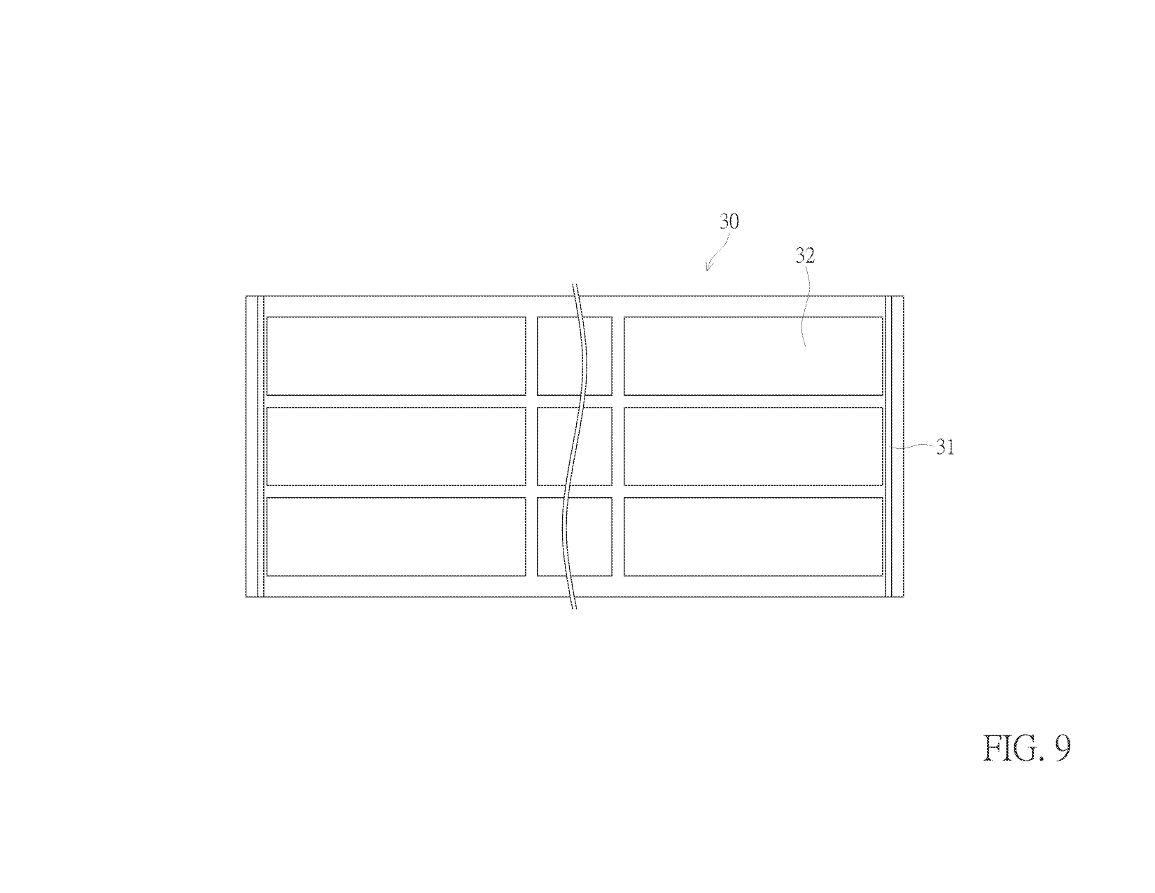

Then please refer to FIG. 2, FIG. 8, and FIG. 9. The door panels 30 are connected to the driving assembly 12 and controlled by the driving assembly 12. When the stacking screen door is open, the door panels 30 can be arranged in a row in the storage area 11. When the stacking screen door is closed, the door panels 30 move downward along the rail 20, and each one of the door panels 30 is sequentially connected vertically to each other and extends from the storage area 11 to the ground level. Each one of the door panels 30 can comprise two electric assemblies 31, multiple display screens 32, and a base 33.

The electric assembly 31 corresponds in position to the conductive bar 24, such that the electric assembly 31 can contact the conductive bar 24 when the door panel 30 is located in the rail 20 and form an electrical connection for supplying electrical energy. The two electric assemblies 31 can be located at the two ends of the door panel 30 or at the same end of the door panel 30, depending on the location of the conductive bar 24. In this embodiment, there are four electric assemblies 31 in total. Either end of the door panel 30 is provided with two electric assemblies 31, and the two electric assemblies 31 are located on front and back, respectively. Therefore, each one of the electric assemblies 31 can respectively contact one of the conductive bars 24.

Each one of the door panels 30 can be a board, the display screens 32 are arranged on the board, and thereby the display screens 32 of the door panels 30 are connected to form a big screen when the stacking screen door is closing. In another embodiment, each one of the door panels 30 can comprise multiple boards, the boards are arranged in connection with each other, and each one of the boards comprises a respective display screen 32. The display screens 32 are electrically connected to the electric assemblies 31, so that the electrical energy is supplied to the display screen 32 through the conductive bars 24 and the electric assemblies 31.

The base 33 is mounted on the bottom of a lowermost one of the door panels 30, thereby providing a cushion to protect the door panels 30 when all the door panels are descended.

Then please refer to FIG. 1, FIG. 2, and FIG. 6. When the stacking screen door is closed, the door panels 30 sequentially enter the rails 20 along the inclines 26 from the storage area 11. Through the guidance of the incline 26, each door panel 30 can smoothly enter the rail 20 without being stuck on another door panel 30. After the door panel 30 enters the rail 20, the electric assemblies 31 are connected to the conductive bars 24. Electrical signals flow from the conductive bar 24 through the electric assembly 31, the display screen 32, another electric assembly 31, and arrive at another conductive bar 24. In other words, each one of the door panels 30 can form a loop with the conductive bars 24 as soon as entering the rail 20.

The advantage of the present invention is that as soon as any one single door panel 30 enters the rail 20, the display screens 32 on the door panel 30 can receive electrical energy, no need to wait for the stacking screen door to close completely. In addition, since each one of the door panels 30 is an independent circuit, when the electric assembly 31 of one door panel 30 is broken, the operation of the display screens 32 of the other door panels 30 remains unaffected.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A stacking screen door comprising:
a storage area;
a driving assembly located in the storage area;
two rails respectively mounted on two sides underneath the storage area and extending from the storage area to a ground level, and each one of the rails respectively comprising:
a groove extending from the storage area to the ground level and being parallel to the rail;
a conductive bar movably located in the groove and extending from the storage area to the ground level;
an elastic assembly connected to the conductive bar and the groove, and the elastic assembly configured to push the conductive bar out of the groove;
multiple door panels connected to the driving assembly; the door panels selectively mounted in the storage area; the door panels selectively moving along the two rails, and connected vertically to each other in the two rails; each one of the door panels comprising:
two electric assemblies respectively located on the two opposite ends of the door panel;
multiple display screens respectively mounted on the door panel, each one of the display screens electrically connected to the two electric assemblies;
wherein, when each one of the door panels moves along the two rails, each one of the electric assemblies is respectively connected to the conductive bar of the respective one of the rails.

2. The stacking screen door as claimed in claim 1, wherein, the elastic assembly includes multiple springs, and two ends of each one of the springs are respectively connected to the conductive bar and the groove.

3. The stacking screen door as claimed in claim 1, wherein each one of the elastic assemblies includes a wave structure, the wave structure includes multiple peaks and multiple troughs, and the peaks and the troughs are arranged staggered; the peaks are connected to the conductive bar, and the troughs are connected to the groove.

4. The stacking screen door as claimed in claim 1, wherein, the groove comprises an opening, and the conductive bar protrudes from the opening of the groove.

5. The stacking screen door as claimed in claim 2, wherein, the groove comprises an opening, and the conductive bar protrudes from the opening of the groove.

6. The stacking screen door as claimed in claim 3, wherein, the groove comprises an opening, and the conductive bar protrudes from the opening of the groove.

7. The stacking screen door as claimed in claim 1, wherein each one of the two rails comprises:
an insulation layer located between the elastic assembly and the groove and surrounding the conductive bar and the elastic assembly; and
a metal layer located between the elastic assembly and the insulation layer, and the metal layer surrounding the conductive bar and the elastic assembly; the metal layer electrically connected to the conductive bar.

8. The stacking screen door as claimed in claim 5, wherein each one of the two rails comprises:
an insulation layer located between the elastic assembly and the groove and surrounding the conductive bar and the elastic assembly; and
a metal layer located between the elastic assembly and the insulation layer, and the metal layer surrounding the conductive bar and the elastic assembly; the metal layer electrically connected to the conductive bar.

9. The stacking screen door as claimed in claim 6, wherein each one of the two rails comprises:
an insulation layer located between the elastic assembly and the groove and surrounding the conductive bar and the elastic assembly; and
a metal layer located between the elastic assembly and the insulation layer, and the metal layer surrounding the conductive bar and the elastic assembly; the metal layer electrically connected to the conductive bar.

10. The stacking screen door as claimed in claim 1, wherein, the door panel comprises multiple boards, the boards are connected to each other, and each one of the boards comprises a respective one of the display screens.

11. The stacking screen door as claimed in claim 8, wherein, the door panel comprises multiple boards, the boards are connected to each other, and each one of the boards comprises a respective one of the display screens.

12. The stacking screen door as claimed in claim 9, wherein, the door panel comprises multiple boards, the boards are connected to each other, and each one of the boards comprises a respective one of the display screens.

13. The stacking screen door as claimed in claim 1, wherein, each one of the two rails comprises an incline near an end of the storage area; when the door panels move between the storage area and the two rails, the door panels enter or leave the two rails along the inclines of the two rails.

14. The stacking screen door as claimed in claim 11, wherein, each one of the two rails comprises an incline near an end of the storage area; when the door panels move between the storage area and the two rails, the door panels enter or leave the two rails along the inclines of the two rails.

15. The stacking screen door as claimed in claim 12, wherein, each one of the two rails comprises an incline near an end of the storage area; when the door panels move between the storage area and the two rails, the door panels enter or leave the two rails along the inclines of the two rails.

16. The stacking screen door as claimed in claim 13, wherein, the inclines are formed on tops of the conductive bars of the two rails respectively.

17. The stacking screen door as claimed in claim 1 further comprising a base, the base mounted on a bottom of a lowermost one of the door panels.

18. The stacking screen door as claimed in claim 14, further comprising a base, the base mounted on a bottom of a lowermost one of the door panels.

19. The stacking screen door as claimed in claim 15, further comprising a base, the base mounted on a bottom of a lowermost one of the door panels.

20. A stacking screen door comprising:
a storage area;
a driving assembly located in the storage area;
two rails respectively mounted on two sides underneath the storage area, extending from the storage area to a ground level; one of the rails comprising:
a groove extending from the storage area to the ground level and being parallel to the rail;
two conductive bars movably located in the groove, and extending from the storage area to the ground level;
two elastic assemblies connected to the groove and the two conductive bars, the elastic assemblies configured to push the conductive bars out of the groove;
multiple door panels connected to the driving assembly; the door panels selectively mounted in the storage area; the door panels selectively moving along the two rails, and connected vertically to each other in the two rails; each one of the door panels comprising:
two electric assemblies respectively located on a same end of the door panel;
multiple display screens respectively mounted on the door panel, each one of the display screens electrically connected to the two electric assemblies;
wherein, when each one of the door panels moves along the two rails, the two electric assemblies are each respectively connected to the two conductive bars of the rail.
